(19) United States
(12) Patent Application Publication
(10) Pub. No.: US 2015/0320111 A1
(43) Pub. Date: Nov. 12, 2015

(54) CONTAINER WITH GUIDE ELEMENT FOR ADHESIVE

(71) Applicant: PHILIP MORRIS PRODUCTS S.A., Neuchatel (CH)

(72) Inventor: Arjen Hamilcar Slooff, Lausanne (CH)

(21) Appl. No.: 14/647,938

(22) PCT Filed: Nov. 19, 2013
(86) PCT No.: PCT/EP2013/003484

§ 371 Date: May 28, 2015

(30) Foreign Application Priority Data
Nov. 30, 2012 (EP) 12008041.1

(51) Int. Cl. A24F 15/12; B31B 13/00

(52) U.S. Cl. CPC A24F 15/12; B31B 13/00

(57) ABSTRACT

The present invention relates to a container (1) for consumer goods, in particular smoking articles (2), comprising container walls, wherein the container is formed from a blank. At least one container wall (9) comprises a fluid guide element (16,17, 18), wherein the at least one container wall is formed from a panel of the blank. Adhesive is provided in the area of the fluid guide element, wherein the container wall is fixed by means of the adhesive to a further component of the container. The invention further relates to a blank, a method for forming a container from a blank, and the use of a fluid guide element provided on a wall of a container.

The invention relates to a container for consumer goods, in particular smoking articles, wherein at least one container wall is fixed by means of adhesive to a further component of the container. The invention further relates to a blank and a method for forming a container from a blank with at least one panel.

It is known in the prior art that components of containers are fixed to each other by means of adhesive. U.S. Pat. No. 6,041,952 A discloses a container apparatus for a liquid, namely a bottle, which comprises a recessed and circumferentially extending cylinder wall, in which an insulative sleeve is fixed by means of an adhesive layer.

To form cardboard containers, it is known in the prior art that different panels of a blank may be attached to each other by means of adhesive, wherein the different panels depend from each other via folding lines.

Furthermore, additional packaging components, such as inner liner or outer wrappers of a container may be attached to a box part or a lid part of a container. For example, WO-A-2008/142540 A1 discloses a container for smoking articles, wherein an inner liner is provided around a bundle of smoking articles. The inner liner is housed inside of the box of a container and a hingeable lid. The inner liner comprises a cover flap, which covers an opening in the inner liner, wherein the cover flap is attached by means of a permanent adhesive to the lid, so that opening and closing the lid simultaneously also opens and closes the cover flap of the inner liner.

However, it may be a problem that adhesive provided to attach the components of containers to each other may distribute in an uncontrolled manner, for example due to of the pressure applied to the components during the attaching process, such that the adhesive is also present in undesired locations. This may lead to parts of the container to be attached together unintentionally. For example, the lid of a container may be involuntarily glued to the box of a container, such that the container cannot be opened easily.

It is an object of the present invention to provide a container, a blank and a method for forming a container that guarantees a controlled distribution of adhesive. It is a further objective of the invention, to prevent that components of the container are unintentionally attached by means of adhesive.

According to the invention a container for consumer goods, in particular smoking articles, is provided, comprising container walls, wherein at least one container wall has a fluid guide element, and adhesive is provided in the area of the fluid guide element, wherein the at least one container wall is fixed by means of the adhesive to a further component of the container.

The container is formed from a blank, and the at least one container wall is formed from a panel of the blank. In particular, the blank may be a cardboard blank. It may also be a flat polymer blank. The panels of the blank preferably depend from each other via folding lines, and may be folded along these folding lines to form the container. Alternatively, the container may comprise a ready formed structure such as plastic box, in particular formed by injection molding, to which the further component is fixed by means of the adhesive.

Throughout the specification, the term “component” is used to refer to any wall, panel or flap of the container, the container blank or blanks or other elements of the packaging as for example inner liner, inner frame, outer wrapper or others. This specifically also includes elements of a container that are not provided on the same blank that forms the wall with the fluid guide element.

Throughout the specification, the term “wall” is used to refer to a wall of the assembled container. In contrast, the term “panel” is used to refer to elements of the laminar blank or blanks that the container is assembled from. Consequently, a container wall can comprise two or more panels that may partially or completely overly each other, for example on the bottom or the sides of the container, depending on the construction of the container. The term “flap” is used to indicate a panel of a blank that is only attached to one other panel across a connecting line, for example a creasing or folding line.

According to the invention, the fluid guide element acts as a barrier or reservoir, which is adapted to guide or receive liquid adhesive. This enables that glue can be provided in desired regions of the container wall to enable that the adhesive connection provides the desired stability. Further, it can be prevented that adhesive is smeared or travels to undesired locations over the fluid guide element. In particular, the fluid guide element enables that excess adhesive does not travel to undesired locations when the container wall is pressed to a further component of the container to which it should be fixed by the adhesive.

The fluid guide element may be a depression, such as a recess or a cut-out in the container wall. Thus, the fluid guide element may act as a reservoir, which is adapted to receive and guide adhesive therein, and reduces the smearing or traveling of glue out of the fluid guide element.

Alternatively, the fluid guide element may be a protrusion, such as an integrally formed protrusion of the container wall, or an additional spacer provided on the container wall. Thus, the region adjacent to the fluid guide element may act as a reservoir, which is adapted to receive and distribute adhesive, and prevents the smearing or traveling of glue over the fluid guide element.

Thus, adhesive may be guided along or in fluid guide element, and the fluid guide element provides a stop to prevent excess adhesive to pass.

The fluid guide element may also increase the mechanical stability of the container wall.

The adhesive is preferably provided in or next to the fluid guide element. Preferably, the further component is fixed to the at least one container wall, and the adhesive is distributed towards the fluid guide element by means of pressure applied in between the container wall and the further component. Thus, it is prevented, that a significant amount of adhesive travels further than the fluid guide element.

The adhesive is preferably a viscous fluid. Preferably, the adhesive is applied in the form of several glue dots on the at least one container wall or the further component. During construction of the container, the at least one container wall and the further component are brought into contact with each other, in particular by applying pressure, and the adhesive is distributed by means of the pressure, wherein the fluid guide element prevents the traveling of the adhesive to an undesired location.

The fixation of the container wall to the further component relates in particular to a permanent connection. The term “permanent connection” is used herein to refer to a connection between two panels such that the two panels are not separable under normal handling conditions of the container. Such a permanent connection may be achieved by a high tack or permanent adhesive like for example, hot melt. In contrast, the term “non-permanent connection” is used to indicate a connection between two panels that may be opened under normal handling conditions. Such a permanent connection may be achieved by a low tack adhesive.

In one embodiment, the adhesive is at least partially provided in a depression forming the fluid guide element. Alternatively, at least for some containers, the adhesive may not reach the depression, when it is applied in the right amount and in a distance with respect to the depression. Nevertheless, in case the adhesive comes into the region of the depression, a leaking of the adhesive to undesired locations can be prevented.

The at least one container wall is at least locally formed by an outer and an inner panel, which are arranged parallel and adjacent to each other, wherein the fluid guide element is formed in the inner panel. In particular, the inner panel is facing the inside of the container, while the outer panel is provided towards the container outside with respect to the inner panel. As the fluid guide element is formed in the inner panel it is not visible on the outside of the container. In particular, the outer panel forms an outside of the container wall, while the inner panel forms the inside.

In one embodiment, the further component is an inner liner, which encloses a bundle of smoking articles and is arranged in between the smoking articles and the container walls. This may serve the purpose of attaching an inner liner in a container box. The inner liner may be fixed to an openable lid of the container, such that at least a portion of the inner liner moves together with the lid, when the lid is opened. This may enable that the inner liner is torn open when the container is opened for the first time. Further, the inner liner may be reclosable, as the portion of the inner liner attached to the lid may be substantially rearranged in its original position when the lid is closed again. Non-permanent adhesive may be provided on the inner liner to enable a substantially gas tight reclosing to preserve the freshness of the smoking articles in the inner liner after reclosing the container.

Preferably, the inner liner comprises a cover flap, covering a designated opening of the inner liner, and the cover flap is fixed to the inside of the container wall. Thus, the cover flap forms the further component. In particular, the cover flap may be fixed to the inside of a container wall forming the lid of a hinge lid container. Alternatively, the cover flap may be fixed to the slide or shell of a slide and shell container or to the lid of a container with a separate lid. The fixation of the cover flap to a portion of the container which is moved relative to another part of the container enables the opening and reclosing of the cover flap together with the container.

Preferably, the container is a hinge-lid container, comprising a box and a lid and the fluid guide element is provided on the inside of a front wall of the lid, and a part of the inner liner is attached by the adhesive to the inside of the front wall of the lid. In particular, the cover flap of the inner liner is attached to the inside of the front wall of the lid. The cover flap may be attached by non-permanent adhesive to the remaining inner liner to be resealable.

In one embodiment, the further component of the container is a second panel. The fluid guide element for receiving or guiding adhesive to prevent the distribution in undesired locations is in particular beneficial for the connection of panels in a container. These panels may in particular be part of one integral container blank forming at least a part of the container. More specifically, panels which are forming the sides of a hinge lid container, such as a conventional cigarette pack, may be attached by adhesive. Furthermore, an inner panel of a lid front wall of a hinge lid container may be attached to an outer panel of the lid front wall by means of adhesive.

In one embodiment, the second panel, which forms the further component, foldingly depends from the first panel, which forms the first container wall, wherein the second panel is fixed by means of adhesive parallel and adjacent to the first panel, such as to form at least partially a reinforced section of the container wall. This improves the stability of the container wall, and more in particular the stability of the edge which is formed by the folding line in between first and second panel. Furthermore, a folded lower edge of the lid improves the appearance of the edge over a cut edge that would otherwise expose the sheet material in the cut. Additionally, the appearance of the inside of the container can be improved, as with a blank, which is only printed on one side, a printed inside can be provided by a second panel, which is folded to the inside of a first panel.

In a further embodiment, the container is a hinge-lid container, comprising a box and a lid and the second panel is a panel depending via a folding line from the lower front wall of the lid, and being arranged adjacent to the inner side of the front wall of the lid. Thus, the second panel is folded and fixed to the inside of the lid front wall.

In one embodiment, the fluid guide element is in the form of a line. This line is preferably near to an edge of the container wall or panel on which it is provided, and in particular parallel to the edge. It prevents that adhesive reaches the edge, in particular when the adhesive is initially applied in a higher distance to the edge as the depression.

The fluid guide element may be arranged in the form of several parallel lines. This may improve the function of the fluid guide element in certain embodiments, as the adhesive may be better guided by several parallel lines than by only one line.

The fluid guide element may comprise several local nonlinear recesses. The several local nonlinear recesses may form depressions. These nonlinear recesses may in particular be pyramidal or cup-shaped.

Preferably, the fluid guide element is arranged close to an edge of the at least one container wall. This allows that the at least one container wall can be fixed by means of adhesive to the further component close to edge of the container wall. This may increase the stability of the adhesive connection.

The fluid guide element may be a local depression, which may be formed by scoring, creasing, cutting or embossing. Alternatively, or in addition, the fluid guide element may have other physical or chemical properties that influence the progression of adhesive on the panel it is applied to. In particular, the fluid guide elements may be intended to influence the progression by stopping or hindering the adhesive from advancing into a predetermined direction for example by non-mechanical means. Alternatively, or in addition, the fluid guide elements may be intended to promote the adhesive into advancing into a predetermined direction, for example by non-mechanical means. For example, the fluid guide element may have a particular surface coating, for example coatings that are lipo-phobic, hydro-phobic, repellent or attractive, or may influence locally the viscosity of the adhesive, depending on what type of adhesive is used. Further, the area of the fluid guide element may have a certain different roughness or coefficient of friction compared to the base material of the panel. The different roughness or coefficient of friction may prevent the adhesive to advance or slows the adhesive sufficiently to prevent the smearing of the adhesive into unwanted areas. Alternatively, the different roughness or coefficient of friction of the panel with the fluid guide element may accelerate the distribution of the adhesive into a predetermined area, thus preventing the adhesive from smearing into unwanted areas. For example, such a fluid guide element may be applied to the panel by a print, spray or coating process. In a preferred embodiment, the fluid guide element forms a closed frame of the location onto which the adhesive is applied.

The invention further provides a blank for forming a container, wherein the blank comprises at least one panel, wherein the panel is provided with a local fluid guide element adapted to form a reservoir for adhesive. The term “local” is to be understood that the fluid guide element is only provided in a portion of the panel, while the remaining panel is free of the fluid guide element.

The container may in particular be a hinge lid container, comprising a cup shaped box and a lid, wherein the lid is hingedly attached to the box via a hinge line.

The terms “front”, “back”, “upper”, “lower”, “side”, “top”, “bottom” and other terms used to describe relative positions of the components of containers according to the invention refer to the container in an upright position with the lid at the top end and the hinge on the back. The terms “left” and “right” are used with reference to side walls of the container when the container is viewed from the front in its upright position. When the container in the upright position is open, the smoking articles contained in the box may be removed from the upper end of the container. The term “longitudinal” refers to a direction from bottom to top or vice versa the term “height direction” is used to indicate a direction parallel to the longitudinal direction. The term “transverse” refers to a direction perpendicular to the longitudinal direction across the front wall, the back wall or one of the side walls. The terms “depth direction” and “width direction” are used to indicate transverse directions across the depth of the container or the width of the container, respectively.

The term “hinge line” refers to a line about which the lid may be pivoted in order to open the container. A hinge line may be, for example, a fold line or a score line in the back wall of the container. Alternatively, a hinge line may be a fold line or a score line in a piece of material bridging the lower edge of the back wall of the lid and the upper edge of the back wall of the box. Such a piece of material may be, for example, a label that is permanently or removably attached to the back wall of the lid and the back wall of the box. Preferably, the hinge line is positioned along the back wall of the container at a level below the upper edge thereof.

Preferably, the container further comprises an inner frame mounted within the box, wherein the inner frame extends above the upper edges of at least the front wall of the box of the container. The inner frame is therefore visible to the consumer when the lid is opened. The front wall of the inner frame may be printed with indicia which may be the same as, or different to the indicia printed on the front wall of the box. Alternatively, or in addition, the front wall of the inner frame may be cut into a distinctive shape, for example, to reflect the branding of the consumer goods. If required, the inner frame may also comprise a line of weakness to facilitate flattening of the container.

Preferably, the front wall of the inner frame is provided with a cut out portion at the upper edge thereof. This enables more convenient access to the consumer goods within the container, without significantly reducing the surface area of the front wall of the inner frame.

Alternatively, or in addition to an inner frame, the consumer goods within the container may be wrapped with an inner liner, which is visible above the upper edge of the front wall of the box and the front wall of the inner frame (if present) when the container is open.

Containers according to the invention may be in the shape of a rectangular parallelepiped, with right-angled longitudinal and right-angled transverse edges. Alternatively, the container may comprise one or more rounded longitudinal edges, rounded transverse edges, bevelled longitudinal edges or bevelled transverse edges, or combinations thereof. For example, the container according to the invention may comprise, without limitation:
One or two longitudinal rounded or bevelled edges on the front wall, and/or
One or two longitudinal rounded or bevelled edges on the back wall.
One or two transverse rounded or bevelled edges on the front wall, and/or
One or two transverse rounded or bevelled edges on the back wall.
One longitudinal rounded edge and one longitudinal bevelled edge on the front wall, and/or
One transverse rounded edge and one transverse bevelled edge on the back wall.
One or two transverse rounded or bevelled edges on the front wall and one or two longitudinal rounded or bevelled edges on the front wall.
Two longitudinal rounded or bevelled edges on a first side wall or two transverse rounded or bevelled edges on the second side wall.

Where the container comprises one or more rounded edges and is made from a laminar blank, preferably the blank comprises three, four, five, six or seven scoring lines or creasing lines to form the rounded edge in the assembled container. The scoring lines or creasing lines may be either on the inside of the container or on the outside of the container. Preferably, the scoring lines or creasing lines are spaced apart from each other by between about 0.3 mm and 4 mm.

Preferably, the spacing of the creasing lines or scoring lines is in function of the thickness of the laminar blank. Preferably, the spacing between the creasing lines or scoring lines is between about 0.5 and about 4 times larger than the thickness of the laminar blank.

Where the container comprises one or more bevelled edges, preferably the bevelled one or more edges have a width of between about 1 mm and about 10 mm, preferably between about 2 and about 6 mm. Alternatively, the container may comprise a double bevel formed by three parallel creasing lines or scoring lines that are spaced apart such that two distinct bevels form on the edge of the container.

Alternatively to a container with a rectangular transverse cross section, the container may have a for example a polygonal cross section such as triangular, quadrangular or hexagonal, or a cross section which is oval, semi-oval, circular or semi-circular.

Where the container comprises a bevelled edge and is made from a laminar blank, the bevel may be formed by two parallel creasing lines or scoring lines in the laminar blank. The creasing lines or scoring lines may be arranged symmetrically to the edge between a first wall and a second wall. Alternatively, the creasing lines or scoring lines may be arranged asymmetrically to the edge between the first wall and the second wall, such that the bevel extends further into the first wall of the container than into the second wall of the container.

The container may be formed from any suitable materials including, but not limited to, cardboard, paperboard, plastic, metal, or combinations thereof. Preferably, the cardboard has a weight of between about 100 grams per square metre and about 350 grams per square metre.

Containers according to the invention may be used as packages for a variety of consumer goods. In particularly preferred embodiments, containers according to the invention are used to package smoking articles. Containers according to the invention may be advantageously used to package smoking articles including, but not limited to, known lit-end cigarettes, cigars or cigarillos, heated smoking articles comprising a combustible fuel element or heat source and an aerosol-generating substrate (for example cigarettes of the type disclosed in U.S. Pat. No. 4,714,082) and smoking articles for use with electrical smoking systems (for example cigarettes of the type disclosed in U.S. Pat. No. 5,692,525).

Through an appropriate choice of the dimensions thereof, containers according to the invention may be designed to hold different total numbers of smoking articles, or different arrangements of smoking articles. For example, through an appropriate choice of the dimensions thereof, containers according to the invention may be designed to hold a total of between ten and thirty smoking articles.

Containers according to the invention may hold one, two, three four or five separate bundles of consumer goods. The separate bundles may be arranged substantially parallel to the front wall and to the back wall or substantially perpendicular to the front wall and to the back wall.

Within a bundle, the smoking articles may be arranged in different collations, depending on the total number of smoking articles, the dimensions of the smoking articles or the cross sectional shape of the container. For example, the smoking articles may be arranged in a bundle in a single row of five, six, seven, eight, nine or ten. Alternatively, the smoking articles may be arranged in two or more rows. The two or more rows may contain the same number of smoking articles. For example, the smoking articles may be arranged in: two rows of five, six, seven, eight, nine or ten; three rows of five, six, seven, eight, nine, or ten; or four rows of four, five, six or seven. Alternatively, the two or more rows may include at least two rows containing different numbers of smoking articles to each other. For example, the smoking articles may be arranged in: a row of five and a row of six (5-6); a row of six and a row of seven (6-7); a row of seven and a row of eight (7-8); a middle row of five and two outer rows of six (6-5-6); a middle row of five and two outer rows of seven (7-5-7); a middle row of six and two outer rows of five (5-6-5); a middle row of six and two outer rows of seven (7-6-7); a middle row of seven and two outer rows of six (6-7-6); a middle row of nine and two outer rows of eight (8-9-8); or a middle row of six with one outer row of five and one outer row of seven (5-6-7).

Containers according to the present invention may hold smoking articles of the same type or brand, or of different types or brands. In addition, both filterless smoking articles and smoking articles with various filter tips may be contained, as well as smoking articles of differing length (for example, between about 40 mm and about 180 mm), diameter (for example, between about 4 mm and about 9 mm). In addition, the smoking articles may differ in strength of taste, resistance to draw and total particulate matter delivery. Wherein the container comprises more than one bundle, each bundle within the same container may hold the same or different types of smoking articles as listed above.

Preferably, the dimensions of the container are adapted to the length of the smoking articles, and the collation of the smoking articles. Typically, the outer dimensions of the container are between about 0.5 mm to about 5 mm larger than the dimensions of the bundle of smoking articles housed inside the container.

Preferably, containers according to the invention have a height of between about 60 mm and about 150 mm, more preferably a height of between about 70 mm and about 125 mm, wherein the height is measured from the top wall to the bottom wall of the container.

Preferably, containers according to the invention have a width of between about 12 mm and about 150 mm, more preferably a width of between about 70 mm and about 125 mm, wherein the width is measured from the first side wall to the second side wall of the container.

Preferably, containers according to the invention have a depth of between about 6 mm and about 100 mm, more preferably a depth of between about 12 mm and about 25 mm wherein the depth is measured from the front wall to the back wall of the container (comprising the hinge between box and lid).

Preferably, the ratio of the height of the container to the depth of the container is in between about 0.3 to 1 and about 10 to 1, more preferably between about 2 to 1 and about 8 to 1, most preferably between about 3 to 1 and 5 to 1

Preferably, the ratio of the width of the container to the depth of the container is in between about 1 to 1 and about 10 to 1, more preferably between about 2 to 1 and about 8 to 1, most preferably between about 2 to 1 and 3 to 1.

Preferably, the ratio of the height of the lid back wall to the height of the box back wall is between about 0 to 1 (hinge located at the top edge of the container) to about 1 to 1, more preferably, between about 1 to 5 and about 1 to 10, most preferably, between about 1 to 6 to about 1 to 8.

Preferably, the ratio of the height of the lid front wall to the height of the box front wall is between about 1 to 0 (lid covering the entire front wall) to about 1 to 10, more preferably, between about 1 to 1 and about 1 to 5, most preferably, between about 1 to 2 and about 1 to 3.

The exterior surfaces of containers according to the invention may be printed, embossed, debossed or otherwise embellished with manufacturer or brand logos, trade marks, slogans and other consumer information and indicia. Alternatively, or in addition, the exterior surfaces of containers according to the invention may be at least partially covered with lacquer, metallisation, holograms, luminescent material, or any other materials that alter the feel, odour or appearance of the container.

Where the inner housing of a container according to the present invention contains one or more bundles of smoking articles, the smoking articles are preferably wrapped in an inner liner of, for example, metal foil or metallised paper.

Where the container comprises smoking articles, the container may further comprise waste-compartments (for example for ash or butts) or other consumer goods, for example matches, lighters, extinguishing means, breath-fresheners or electronics. The other consumer goods may be attached to the outside of the container, contained within the container along with the smoking articles, in a separate compartment of the container or combinations thereof.

Once filled, containers according to the invention may be shrink wrapped or otherwise over wrapped with a transparent polymeric film of, for example, high or low density polyethylene, polypropylene, oriented polypropylene, polyvinylidene chloride, cellulose film, or combinations thereof in a conventional manner. Where containers according to the invention are over wrapped, the over wrapper may include a tear tape. The tear tape is preferably positioned around the container below the lower edge of the front wall of the lid, such that once the tear tape has been removed, the lid is free to be rotated about the first hinge line. Alternatively, the tear tape may be provided lengthways around the container.

The invention further provides a method for forming a container for smoking articles, comprising the following steps of providing a blank comprising at least one panel, wherein the panel has at least one fluid guide element, locally applying adhesive in the region of the fluid guide element, and attaching a further component of the container to the panel by means of the adhesive.

In particular, first, a blank comprising at least one panel is provided, wherein the panel has at least one fluid guide element. Then, adhesive is locally applied in the region of the fluid guide element. A further component of the container is fixed to the panel by means of the adhesive.

The panel may be already initially provided with the fluid guide element, namely the fluid guide element may be applied or formed before step i). In particular, the blank may already be initially provided with a depression in one embodiment of the method.

Alternatively, the step of providing a blank comprises applying or forming the fluid guide element.

In particular, the step of providing a blank comprises the forming of the fluid guide element as a depression in the panel. This may be carried out in a printer printing the panel, may be carried out inline together with the folding of the blank to form a container, or may be carried out inline together with the application of the adhesive.

The fluid guide element may be formed by scoring, creasing, cutting or embossing. The embossing may also be effected from the opposite side of the panel with respect to the side on which the fluid guide element is provided.

The invention further provides the use of a fluid guide element provided on a wall of a container for smoking articles, to guide adhesive, which is provided in the region of the fluid guide element, when the container wall is fixed by means of the adhesive to a further component of the container.

The invention will now be further explained with reference to exemplary embodiments as shown in the following figures.

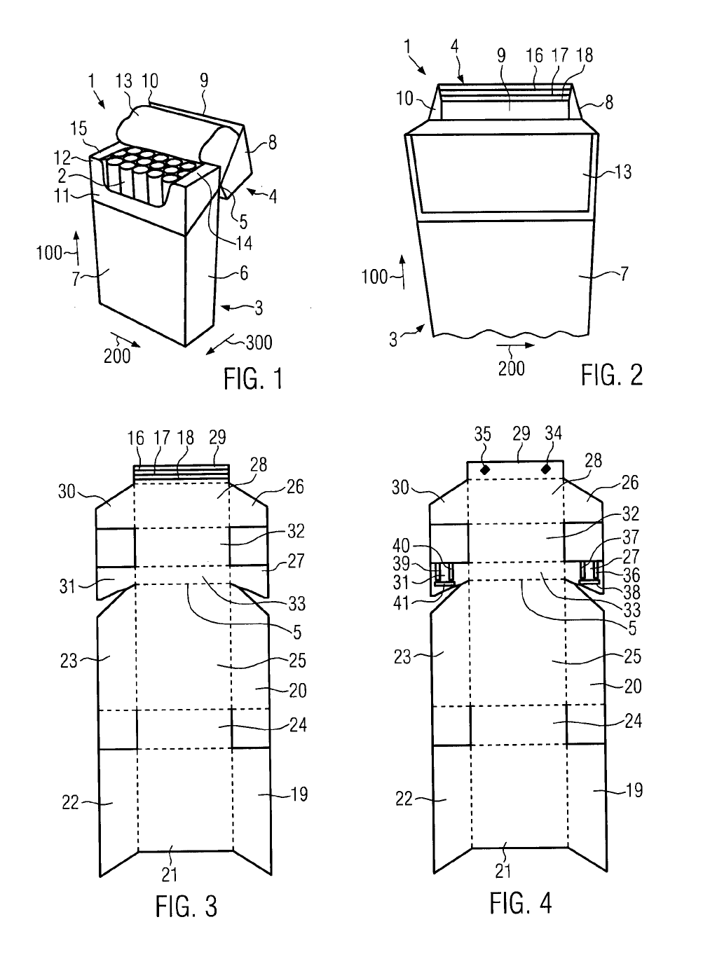

FIG. 1 shows a perspective view of a container according to a first embodiment of the invention;

FIG. 2 shows a frontal perspective view of a container according to the first embodiment of the invention;

FIG. 3 shows a plan view of a blank for forming a container according to a first embodiment of the invention; and

FIG. 4 shows a plan view of a blank for forming a container according to a second embodiment of the invention.

In FIG. 1, a container 1 according to a first embodiment of the invention is shown in a perspective view. The container 1 comprises several smoking articles 2, in particular cigarettes. The smoking articles 2 are each oriented in the longitudinal direction, which corresponds to the height direction 100, when the container 1 is in the upright orientation as shown in FIG. 1. The smoking articles 2 are arranged in several rows, in which smoking articles are provided adjacent to each other in the width direction 200. In particular, three rows of smoking articles 2 are provided parallel to each other in the depth direction 300 of the container 1.

The container comprises a box 3, which is substantially cup-shaped, and a lid 4, which is hingedly attached via a hinge line 5 at an upper end of a box back wall. The container box 3 further comprises a box right side wall 6, a box front wall 7, a box left side wall, and a box bottom wall. The lid 4 of the container 1 comprises a lid back wall attached via the hinge line 5 to the box back wall, a lid right side wall 8, a lid front wall 9, a lid left side wall 10 and a lid top wall. The respective container walls are arranged substantially perpendicular with respect to their adjacent container walls, such that the container 1 is substantially a cuboid, when the lid 4 is in its closed position.

In the container 1 an inner package 11 is provided, which comprises the smoking articles 2. The inner package 11 serves the purpose of preserving the freshness of the smoking articles 2. This is particularly important, if the smoking articles 2 comprise volatile components, such as for example, menthol flavor, which may otherwise evaporate. The inner package 11 comprises in particular an inner frame 12 which can be closed at its upper end by a cover flap 13. The inner frame 12 may have a certain structural stability, and may fully enclose the smoking articles 2 apart from the upper opening, which is closed by means of the cover flap 13. The inner package 11 may at least be partially formed by an inner liner, wherein the cover flap 13 may also be part of the inner liner.

In particular, the inner package 11 comprises a right top wall 14 and a left top wall 15 to which the cover flap 13 is detachably fixed with low tack adhesive, when it is in its closed position. Furthermore, the cover flap 13 is also fixed with low tack adhesive to the front side of the inner package 11 to fully cover the opening of the inner package 11.

To enable that the cover flap 13 is opened, when the lid 4 is hinged into an open position as shown in FIG. 1, the cover flap 13 is fixed by means of adhesive, in particular permanent glue, to the inner side of the lower end of the lid front wall 9. As the adhesive is supplied very close to the corner edge of the lid front wall, there is the risk that some of the adhesive would come in contact with the box of the containers known in the prior art. This could cause that the lid 4 and the box 3 are involuntarily fixed together by means of adhesive, preventing a smooth opening of the container 1. However, according to the invention, fluid guide elements 16, 17, 18, as explained in the following with respect to FIG. 2, are provided on the inner side of the lid front wall 9 and prevent that adhesive reaches any undesired location.

In FIG. 2, the container 1 is shown in a perspective upper front side view, wherein the lid 4 is again in the open position with respect to the box 3. However, the cover flap 13 is not yet fixed to the lid 4, and therefore, it still remains in its closed position covering the opening of the inner package 11.

At the inner side of the lid front wall 9, the fluid guide elements 16, 17, 18 are provided as three line-shaped parallel depressions in the width direction 200. When the cover flap 13 is fixed to the inner side of the lid front wall 9, adhesive is either provided on the lower part of the cover flap 13, or on the inside of the lid front wall 9 in the region of the fluid guide elements 16, 17, 18, or both. Then, the lid front wall 9 and the cover flap 13 are pressed together, such that the adhesive bonds the inner side of the lid front wall to the lower end of the cover flap 13. During the application of pressure, the adhesive which is still in a viscous liquid state, travels. However, the fluid guide elements 16, 17, 18 prevent that the adhesive travels significantly in the height direction 100 over the fluid guide elements 16, 17, 18 and promote that the adhesive travels in the width direction 200 along the fluid guide elements 16, 17, 18. Furthermore, as the fluid guide elements 16, 17, 18 are formed as depressions, they provide a reservoir in which the adhesive accumulates, such that sufficient adhesive can be provided for a stable connection in between the inner side of the lid front wall 9 and the cover flap 13. Thus, the lid front wall 9 is the at least one container wall, which is fixed to a further component, namely the cover flap 13.

In FIG. 3, a blank according to a first embodiment of the invention is shown, which enables to form a container as shown in FIGS. 1 and 2. In the blank according to FIG. 3, dashed lines indicate folding lines via which the panels depend from each other.

The box right side wall is formed by the outer box right side wall panel 19 and the inner box right side wall panel 20, the box front wall 7 is formed by the box front wall panel 21, the box left side wall is formed by the outer box left side wall panel 22 and the inner box left side wall panel 23. The box bottom wall is formed by the box bottom wall panel 24, and the box back wall is formed by the box back wall panel 25.

The lid right side wall is formed by the outer lid right side wall panel 26 and the inner lid right side wall panel 27. The lid front wall 9 is formed by the outer lid front wall panel 28 and the inner lid front wall panel 29. The inner lid front wall panel 29 is smaller than the outer lid front wall panel 28. The lid left side wall 10 is formed by the outer lid left side wall panel 30 and the inner lid left side wall panel 31. The lid top wall is formed by the lid top wall panel 32. The lid rear wall is formed by the lid rear wall panel 33. The lid rear wall panel 33 and the box rear wall panel 25 depend from each other via the hinge line 5.

On the inner lid front wall panel, the fluid guide elements 16, 17, 18 are provided, wherein instead of three fluid guide elements 16, 17, 18, also only one, two, or more than three fluid guide elements could be provided. The fluid guide elements 16, 17, 18 are depressions in the form of a line formed by scoring, creasing, cutting or embossing the inner lid front wall panel 29.

The inner lid front wall panel 29 is generally folded by about 180 degrees from the position as shown in FIG. 3 onto the inner side of the outer front lid wall panel 28 and fixed thereto by means of adhesive. Thus, the fluid guide elements 16, 17, 18 in the form of depressions are not visible from the outside of the container. In particular, the depressions forming the fluid guide elements 16, 17, 18 are embossed in the direction towards the outer lid front wall panel 28, such that the depressions are capable of receiving adhesive which is provided to the inside of the lid front wall 9 as shown in FIG. 2. The fluid guide elements 16, 17, 18 may be provided as weakening lines in order to create reservoirs. In particular, the weakening lines are created by scoring, creasing, cutting or other techniques. The fluid guide elements 16, 17, 18 act as reservoirs to capture excess adhesive which is squeezed due to the pressure in between the cover flap 13 and the inside of the lid front wall 9.

In other embodiments, the fluid guide elements 16, 17, 18 may also be formed as depressions which are embossed in the other direction, such that they create an adhesive reservoir in between the inner lid front wall panel 29 and the outer lid front wall panel 28. Thus, this configuration allows attaching the inner lid front wall panel 29 to the outer lid front wall panel 28 while preventing that excess adhesive is pressed outside the area in between these two panels. Thus, inner lid front wall panel 29 can be considered the at least one container wall, which is fixed to a further component, namely the outer lid front wall panel 28.

Furthermore, as the fluid guide elements 16, 17, 18 are also effective when they are provided as protrusions and not only as depressions, a beneficial effect regarding the fixation of the cover flap 13 to the inside of the lid front wall 9 of the container 1 can be obtained. The fluid guide elements 16, 17, 18 in the form of linear depressions can additionally or alternatively be formed in the outer lid front wall panel 28.

In FIG. 4, a second embodiment for a blank according to the invention is shown in a plan view, wherein this blank allows forming another container according to the invention.

The blank according to FIG. 4 comprises substantially the same panels in the same arrangement as the blank in FIG. 3. However, instead of the linear shaped fluid guide elements 16, 17, 18 as shown in FIG. 3, the inner front wall panel 29 is provided with discrete cup-shaped or pyramidal depressions, which each form a fluid guide element 34, 35. Thus, the fluid guide elements 34, 35 form a reservoir in which adhesive can be provided and prevent that adhesive is extensively smeared in the region around the fluid guide elements 34, 35. Thus, a stable connection in between the inner lid front wall panel 29 and the cover flap 13 can be enabled, while preventing the involuntary attaching of other portions of the container to each other.

The blank further comprises fluid guide elements 36, 37 and 38 in the inner lid right side wall panel 27. The fluid guide elements 36, 37 are linear depressions which are substantially extending in the height direction 100 of the assembled container 1, while the fluid guide element 38 is arranged as a linear depression substantially extending in the depth direction 300. In this embodiment the inner lid right side wall panel 27 can be considered the container wall, while the outer lid right side wall panel 26 is the further component.

By providing a configuration in which fluid guide elements are provided which are extending in different directions, it can be enabled that adhesive distributes in a certain area along the fluid guide elements 36, 37, but is then stopped by the fluid guide element 38, such that it cannot reach the area in between the lid 4 and the box 3 of the container 1. Thus, an involuntary connection in between the lid 4 and the box 3 by means of excess adhesive can be prevented. The fluid guide elements 36, 37, 38 serve the purpose of distributing adhesive in between the inner lid right wall panel 27 and the outer lid right wall panel 26.

Similarly, the inner lid left side wall panel 31 is provided with fluid guide elements 39, 40 and 41 to facilitate the attaching of the inner lid left side wall panel 31 to the outer lid left side wall panel 30.

Generally, it is preferred that the fluid guide elements are provided in inner panels, as then they are not visible from the outside of the container. Generally, the inner panels are those panels which are arranged towards the inside of the container with respect to the outer panels.

In the following, an exemplary embodiment of the method according to the invention is described.

Initially, a blank is provided, which generally has the same configuration of panels as shown in FIGS. 3 and 4. Then, fluid guide elements are provided on predetermined panels, which are later subject to a fixation by adhesive to other panels of the blank or to further components of the container. The fluid guide elements may particularly be created by means of embossing the respective panels. Then, an inner package 11 comprising smoking articles 2 is arranged on the box back wall panel 25, and the remaining panels are folded around the inner package 11. In particular, adhesive may be provided before, at the same time or after the inner package 11 is arranged on the back side wall 25 of the box 3. As at least in some of the locations, where the adhesive is provided, the fluid guide elements have already been created in the panels, it can be prevented that the adhesive reaches undesired locations when the panels are pressed to each other or to further components to fix the parts of the container with respect to each other.

In particular, the fluid guide element may not only act as a reservoir for adhesive or as a stop means to prevent adhesive from flowing to undesired locations, but also as a means of distributing adhesive to desired locations. This enables in particular, that during the application of adhesive, the adhesive does not have to be distributed on the panel already, which would require more complex machinery. Instead, according to the invention, a local application of adhesive may be sufficient, and the fluid guide element provides the function of distributing the adhesive to the desired locations in the panel.

1. A container for consumer goods, comprising container walls, wherein the container is formed from a blank, wherein at least one container wall comprises a fluid guide element and adhesive is provided in the area of the fluid guide element, wherein the at least one container wall is formed from a panel of the blank, and wherein the container wall is fixed to a further component of the container with the adhesive.

2. The container according to claim 1, wherein the adhesive is at least partially provided in a depression forming the fluid guide element.

3. The container according to claim 1, wherein the at least one container wall is at least locally formed by an outer panel and an inner panel, which are arranged parallel and adjacent to each other, wherein the fluid guide element is formed in the inner panel.

4. The container according to claim 1, wherein the further component is an inner liner, which encloses a bundle of smoking articles and is arranged in between the smoking articles and the container walls.

5. The container according to claim 4, wherein the inner liner comprises a cover flap, covering a designated opening of the inner liner, and the cover flap is fixed to the inside of the container wall.

6. The container according to claim 4, wherein the container is a hinge-lid container, comprising a box and a lid and the fluid guide element is provided on the inside of a front wall of the lid, and a part of the inner liner is attached by the adhesive to the inside of the front wall of the lid.

7. The container according to claim 1, wherein the fluid guide element is in the form of a line.

8. The container according to claim 1, wherein the fluid guide element is arranged in the form of several parallel lines.

9. The container according to claim 1, wherein the fluid guide element comprises several local nonlinear recesses.

10. Blank for forming a container, wherein the blank comprises at least one panel, wherein the panel is provided with a local fluid guide element adapted to form a reservoir for adhesive.

11. A method for forming a container for smoking articles, comprising the following steps:
i) Providing a blank comprising at least one panel, wherein the panel has at least one fluid guide element,
ii) locally applying adhesive in the region of the fluid guide element, and
iii) attaching a further component of the container to the panel with the adhesive.

12. The method according to claim 11, wherein step i) comprises the forming of the fluid guide element as a depression in the panel.

13. The method according to claim 11, wherein the fluid guide element is formed by scoring, creasing, cutting or embossing.

14. A method comprising, guiding adhesive into a fluid guide element provided on a wall of a container for smoking articles, and fixing the container wall with the adhesive to a further component of the container.

15. The container according to claim 2, wherein the at least one container wall is at least locally formed by an outer panel and an inner panel, which are arranged parallel and adjacent to each other, wherein the fluid guide element is formed in the inner panel.

16. The container according to claim 2, wherein the further component is an inner liner, which encloses a bundle of smoking articles and is arranged in between the smoking articles and the container walls.

17. The container according to claim 3, wherein the further component is an inner liner, which encloses a bundle of smoking articles and is arranged in between the smoking articles and the container walls.

18. The container according to claim 5, wherein the container is a hinge-lid container, comprising a box and a lid and the fluid guide element is provided on the inside of a front wall of the lid, and a part of the inner liner is attached by the adhesive to the inside of the front wall of the lid.

19. The container according to claim 18, wherein the fluid guide element is in the form of a line.

20. The method according to claim 12, wherein the fluid guide element is formed by scoring, creasing, cutting or embossing.
